(19) United States
(12) Patent Application Publication
(10) Pub. No.: US 2014/0236970 A1
(43) Pub. Date: Aug. 21, 2014

(54) REFRESHING WIRELESS CARRIERS' LICENSE DATA

(71) Applicant: AllNet Labs LLC, Bellevue, WA (US)

(72) Inventor: Brian Roy Goemmer, Bellevue, WA (US)

(73) Assignee: ALLNET LABS LLC, Bellevue, WA (US)

(21) Appl. No.: 14/179,385

(22) Filed: Feb. 12, 2014

Related U.S. Application Data
(60) Provisional application No. 61/765,614, filed on Feb. 15, 2013.

(51) Int. Cl. G06Q 30/02

(52) U.S. Cl. CPC G06Q 30/0201
USPC 707/752

(57) ABSTRACT

The FCC license data for wireless spectrum is publicly available information. By processing the data, user interfaces are presented to better understand how specific license data relates to each carrier's spectrum ownership within a frequency band and within a market.

### CROSS-REFERENCE TO RELATED APPLICATION

This application claims the benefit of Provisional Application No. 61/765614, filed Feb. 15, 2013, which is incorporated herein by reference.

### TECHNICAL FIELD

The present subject matter is generally related to wireless licensing, and more particularly, it relates to updating and displaying wireless carriers' license data.

### BACKGROUND

The Federal Communications Commission (FCC) is an independent agency of the United States government. The FCC works in the areas of broadband, competition, the spectrum, the media, public safety, and homeland security. The FCC is organized into seven bureaus. One of the bureaus, called the Wireless Telecommunication Bureau (WTB), is responsible for wireless licensing and oversees licenses connected with fixed, mobile, and broadcast services on the 700 megahertz band, the cellular band, the Personal Communications Service (PCS) band, the Advanced Wireless Service (AWS) band, the Wireless Communication Service (WCS) band, the Educational Broadcast Service (EBS), and the Broadband Radio Service (BRS). The WTB is also involved in licensing the Mobile Satellite Service (MSS) band for terrestrial services. FCC license data is publicly available information, but it is difficult to understand how specific license data relates to each carrier's spectrum ownership within a frequency band and within a market.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

An aspect of the subject matter includes a method form reciting a method that comprises accessing a data source containing wireless carriers' license data. The method also comprises downloading the wireless carriers' license data to obtain downloaded data. The method additionally comprises sorting the downloaded data to obtain sorted data. The method further comprises reducing the sorted data to reduced data within a set of markets, states, and counties. The method as yet further comprises manipulating the reduced data to code each county of a license with a key comprising a state, a county, and a spectrum code, so as to form manipulated data. The method presents the manipulated data by using the key as a lookup value so as to display the wireless carriers' license data in a spectrum matrix.

Another aspect of the subject matter includes a computer-readable medium form reciting a non-transitory computer-readable medium having computer-executable instructions stored thereon to implement a method that comprises accessing a data source containing wireless carriers' license data. The method also comprises downloading the wireless carriers' license data to obtain downloaded data. The method additionally comprises sorting the downloaded data to obtain sorted data. The method further comprises reducing the sorted data to reduced data within a set of markets, states, and counties. The method as yet further comprises manipulating the reduced data to code each county of a license with a key comprising a state, a county, and a spectrum code, so as to form manipulated data. The method presents the manipulated data by using the key as a lookup value so as to display the wireless carriers' license data in a spectrum matrix.

A further aspect of the subject matter includes a system form reciting a system that comprises a computer, the hardware structures of which are suitable to implement the steps of accessing a data source containing wireless carriers' license data; downloading the wireless carriers' license data to obtain downloaded data; sorting the downloaded data to obtain sorted data; reducing the sorted data to reduced data within a set of markets, states, and counties; and manipulating the reduced data to code each county of a license with a key comprising a state, a county, and a spectrum code, so as to form manipulated data. The system further recites a display, the hardware structure of which is capable of presenting the manipulated data by using the key as a lookup value so as to display the wireless carriers' license data in a spectrum matrix.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram illustrating wireless carriers' license data which has been downloaded from the FCC;

FIG. 2 is a pictorial diagram illustrating exemplary wireless carriers' license data which has been manipulated;

FIG. 3 is a pictorial diagram illustrating exemplary spectrum codes corresponding to various starting frequencies;

FIG. 4 is a pictorial diagram illustrating a legend showing exemplary codes identifying the carriers and/or spectrum holders;

FIG. 5 is a pictorial diagram illustrating an exemplary user interface showing the spectrum ownership landscape of bands selected from a group consisting essentially of 700 megahertz, cellular, and AWS;

FIG. 6 is a pictorial diagram illustrating an exemplary user interface showing the spectrum ownership landscape of bands selected from a group consisting essentially of AWS and PCS;

FIG. 7 is a pictorial diagram illustrating an exemplary user interface showing the spectrum ownership landscape of bands selected from a group consisting essentially of WCS, EBS, and BRS;

FIG. 8 is a pictorial diagram illustrating an exemplary user interface showing carriers (companies) by band summary;

FIG. 9 is a pictorial diagram illustrating an exemplary user interface showing market by band summary;

FIG. 10 is a pictorial diagram illustrating an exemplary user interface showing market by band summary;

FIG. 11 is a pictorial diagram illustrating an exemplary user interface showing LTE (Long Term Evolution) channel summaries;

FIG. 12 is a pictorial diagram illustrating an exemplary user interface showing EBS/BRS percentage of covered population;

FIG. 13 is a pictorial diagram illustrating exemplary information to generate the exemplary user interface of FIG. 12; and

FIGS. 14A-14E are process diagrams illustrating an archetypical method for refreshing wireless carriers' license data.

### DETAILED DESCRIPTION

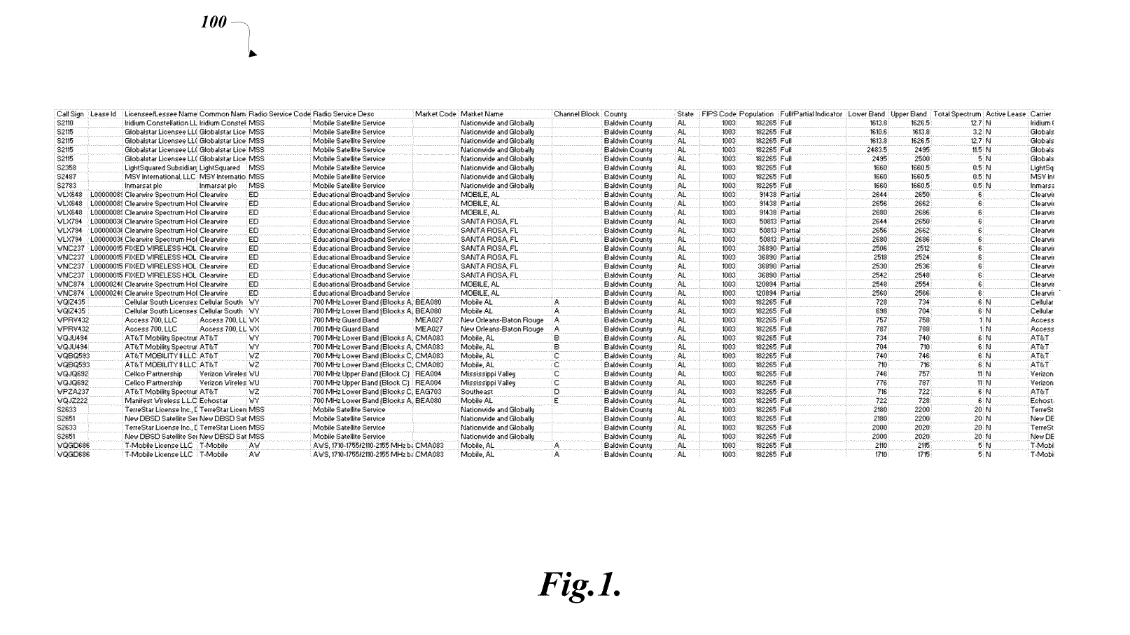

FIG. 1 illustrates wireless carriers' licensed data downloaded from the FCC, specifically the FCC Spectrum Dashboard Web site. The data is organized by various fields, each field being presented as a column of a matrix 100 as shown in FIG. 1. The first column is titled “Call Sign.” The various rows connected with the first column store call signs, which in broadcasting and radio communications, consist of a unique designation for a transmitting station formally assigned by a government agency. The second column is titled “Lease Id.” The rows of the second column contain identifiers of telecommunication leases if available. The third column is titled “Licensee/Lessee Name.” The rows of the third column contain carriers' full legal names. The fourth column is titled “Common Name.” The rows of the fourth column contain shortened versions of the carriers' full legal names. The fifth column is titled “Radio Service Code.” The rows of the fifth column contain abbreviated codes that identify various radio services. The sixth column is titled “Radio Service Description.” The rows of the sixth column contain proper names for the various radio services. The seventh column is titled “Market Code.” The rows of the seventh column contain codes that identify a market in which a carrier is licensed. The eighth column is titled “Market Name.” The rows of the eighth column contain the geographic location at which the carrier is licensed. The ninth column is titled “Channel Block.” The rows of the ninth column contain channel blocks, which are groups of frequencies. The tenth column is titled “County.” The rows of the tenth column contain the counties in which the carrier is licensed. The eleventh column is titled “State.” The rows of the eleventh column contain the states in which the carrier is licensed. The twelfth column is titled “FIPS Code.” The rows of the twelfth column contain Federal Information Processing Standards codes describing counties or states. The thirteenth column is titled “Population.” The rows of the thirteenth column contain the population size of a geographic location in which the carrier operates. The fourteenth column is titled “Full/Partial Indicator.” The rows of the fourteenth column contain information connected with a full assignment involving acquisition of the entire license and licensed facilities or a partial assignment involving acquisition by the assignee of a portion of the facilities, geographic area, or spectrum covered by the license, while the assignor retains the remaining portion. The fifteenth column is titled “Lower Band.” The sixteenth column is titled “Upper Band.” The rows of the fifteenth and sixteenth columns contain the frequencies at which the lower bands and upper bands start. The seventeenth column is titled “Total Spectrum.” The rows of the seventeenth column contain the bandwidth of licensed spectrum. The nineteenth column is titled “Active Lease.” The rows of the nineteenth column indicate whether the spectrum lease is active. The last column is titled “Carrier.” The rows of the last column identify the carriers.

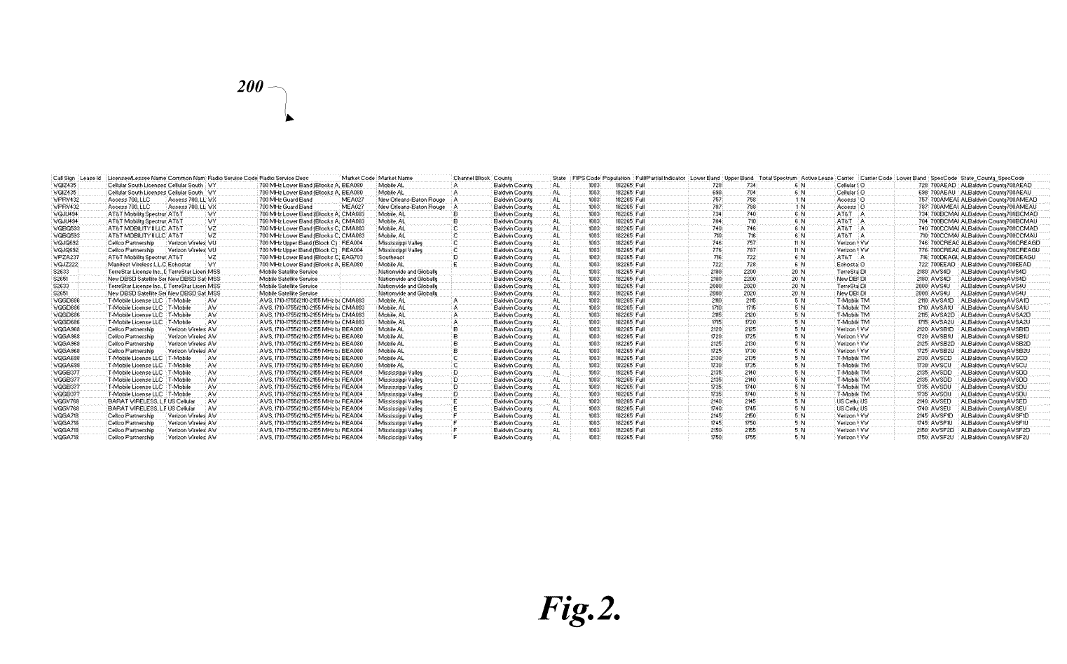

FIG. 2 illustrates wireless carriers' licensed data that has been manipulated to insert a key title “State_County_SpecCode,” which is the last field of a matrix 200 shown in FIG. 2. The matrix 200 organizes the manipulated data in various fields appearing as columns. These columns are similar to those discussed in connection with the matrix 100 of FIG. 1 and for brevity purposes they will not be further discussed. The first column is titled “Call Sign.” The second column is titled “Lease Id.” The third column is titled “Licensee/Lessee Name.” The fourth column is titled “Common Name.” The fifth column is titled “Radio Service Code.” The sixth column is titled “Radio Service Description.” The seventh column is titled “Market Code.” The eighth column is titled “Market Name.” The ninth column is titled “Channel Block.” The tenth column is titled “County.” The eleventh column is titled “State.” The twelfth column is titled “FIPS Code.” The thirteenth column is titled “Population.” The fourteenth column is titled “Full/Partial Indicator.” The fifteenth column is titled “Lower Band.” The sixteenth column is titled “Upper Band.” The seventeenth column is titled “Total Spectrum.” The eighteenth column is titled “Active Lease.” The nineteenth column is titled “Carrier.” The twentieth column is titled “Carrier Code.” The rows of the twentieth column contain abbreviated identifications for the carriers. The twenty-first column is titled “Lower Band,” which is similar to the fifteenth column. The twenty-second column is titled “SpecCode.” The rows of the twenty-second column contain a shortened system of symbols to represent the spectrum band, the channel block, and market code, among other things. The last column is titled “State_County_SpecCode.” The rows of the last column contain a shortened system of symbols to represent the state, county, and the SpecCode (illustrated in the twenty-second column).

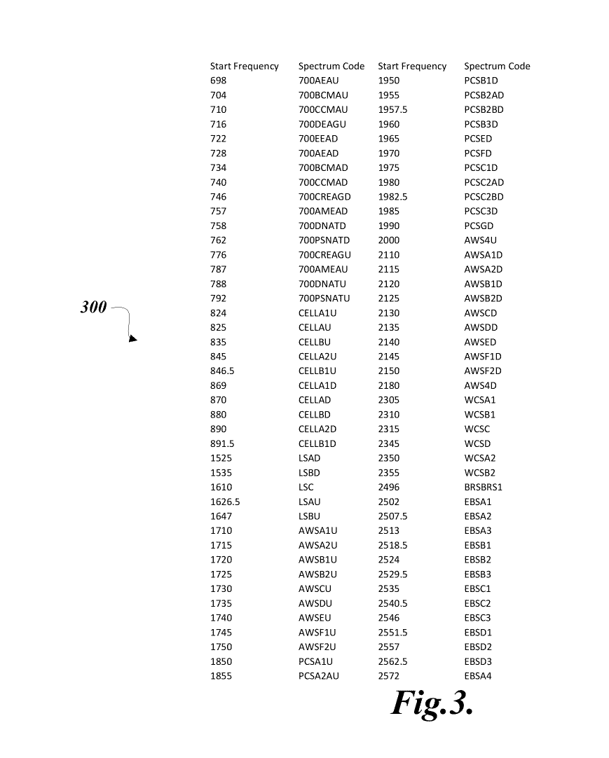

FIG. 3 illustrates a matrix 300 containing spectrum codes in association with various starting frequencies in megahertz. The matrix 300 is in four columns. The first and the third column contain the starting frequencies in megahertz that are contiguous. The second and fourth columns contain the spectrum codes that are connected with the corresponding starting frequencies in the adjacent cells.

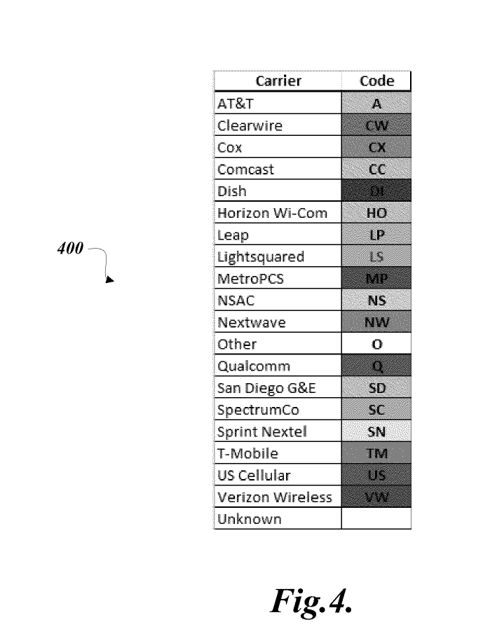

FIG. 4 illustrates a matrix 400 that is a legend in two columns. The first column is titled “Carrier.” The rows of the first column contain identities of carriers. The second column is titled “Code.” The rows of the second column contain abbreviated codes that are used in various pieces of user interface that correspond with the various carriers. For example, the carrier “AT&T” has the code “A”; Clearwire has the code “CW”; Cox is “CX”; Comcast is “CC”; Dish is “DI”; Horizon Wi-Com is “HO”; Leap is “LP”; Lightsquared is “LS”; MetroPCS is “MP”; NSAC is “NS”; Nextwave is “NW”; Other is “O”; Qualcomm is “Q”; San Diego G&E is “SD”; SpectrumCo is “SC”; Sprint Nextel is “SN”; T-Mobile is “TM”; US Cellular is “US”; Verizon Wireless is “VW”; and Unknown is blank.

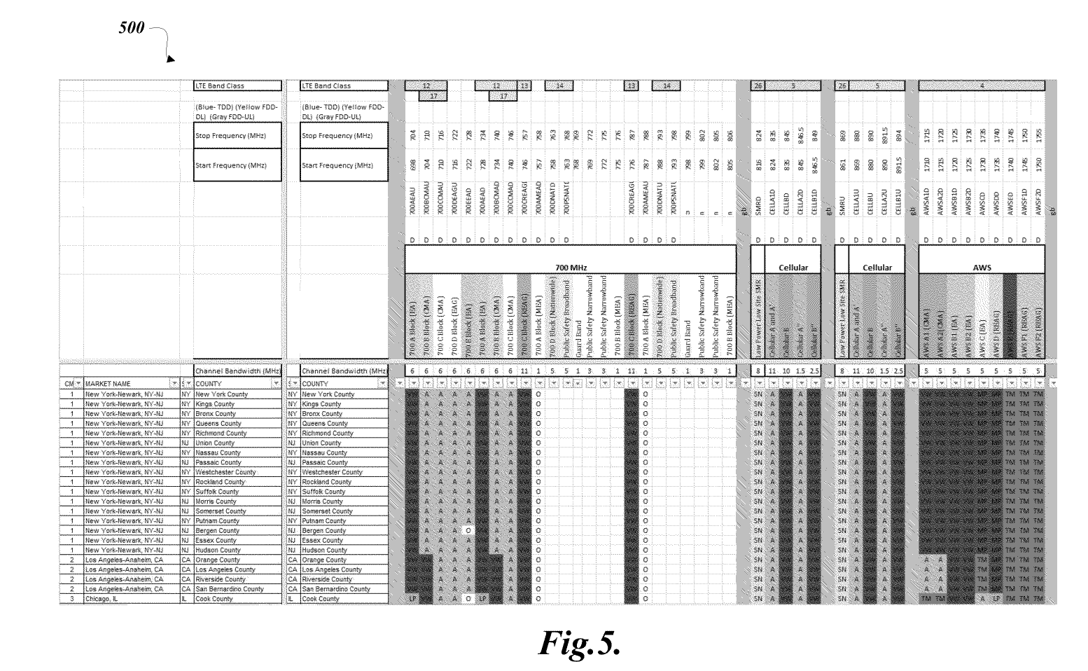

FIG. 5 illustrates a user interface in the form of a matrix 500 showing the spectrum ownership landscape in the bands of 700 megahertz, cellular, and AWS. The first row of the matrix 500 depicts the LTE (Long Term Evolution) Band Class for which the color blue indicates TDD (Time-Division Duplex), the color yellow indicates FDD-DL (Frequency-division duplexing downlink), and the color gray indicates FDD-UL (Frequency-division duplexing uplink). The next row of the matrix 500 depicts the stop frequencies in megahertz. The next row of the matrix 500 depicts the start frequencies in megahertz. The next row depicts spectrum codes. The next row depicts channel block. The next collection of rows depicts sub-bands of a band. For example, the 700 megahertz band is divided into multiple sub-bands, including 700 A Block (EA); 700 B Block (CMA); 700 C Block (CMA); 700 D Block (EAG); 700 E Block (EA); 700 A Block (EA): 700 B Block (CMA); 700 C Block (CMA); 700 C Block (REAG); 700 A Block (MEA); 700 D Block (Nationwide); Public Safety Broadband; Guard Band; Public Safety Narrowband; Public Safety Narrowband; 700 B Block (MEA); 700 C Block (REAG); 700 A Block (MEA); 700 D Block (Nationwide); Public Safety Broadband; Guard Band; Public Safety Narrowband; Public Safety Narrowband; and 700 B Block (MEA). Another example is the cellular band for which sub-bands include Low Power Low Site SMR; Cellular A and A′; Cellular B; Cellular A″; and Cellular B″. A third example includes the AWS band for which sub-bands include AWS A1 (CMA); AWS A2 (CMA); AWS B1 (EA); AWS B2 (EA); AWS C (EA); AWS D (REAG); AWS E (REAG); AWS F1 (REAG); and AWS F2 (REAG). The next row depicts channel bandwidth in megahertz. The next collection of rows depicts market names, states, and counties in which various carriers are licensed.

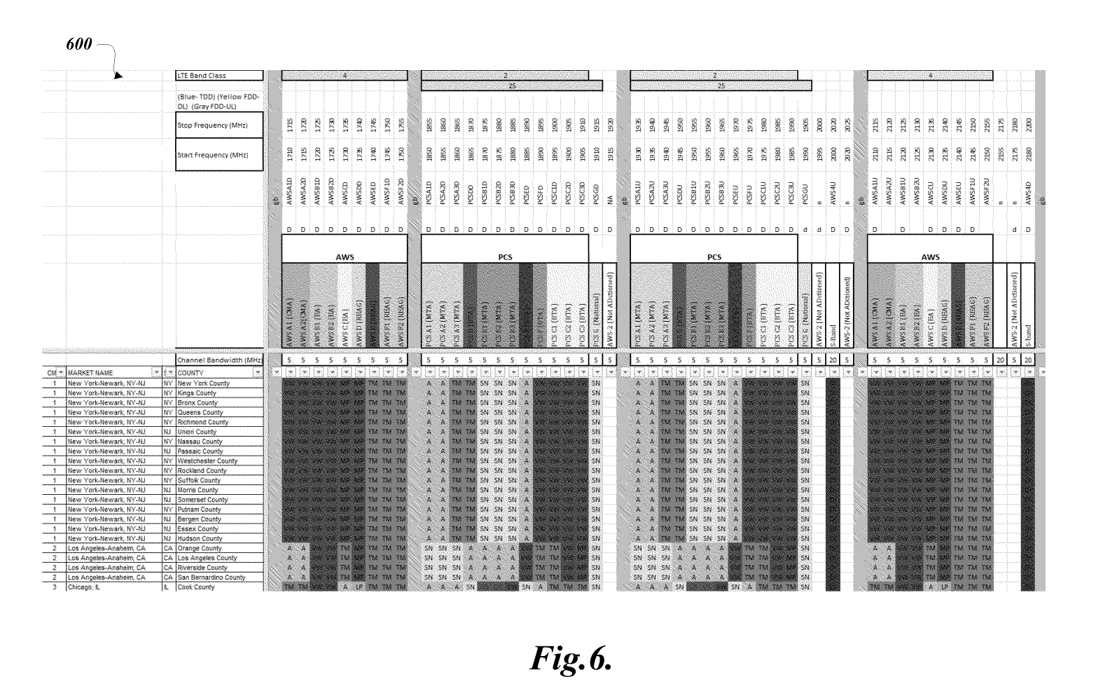

FIG. 6 illustrates a user interface in the form of a matrix 600 showing the spectrum ownership landscape in the bands AWS and PCS. The first row depicts LTE Band Class, which appears in blue if it is TDD, yellow if it is FDD-DL, and gray if it is FDD-UL. The next row illustrates stop frequencies in megahertz. The next row depicts start frequencies in megahertz. The row following depicts spectrum codes. The following row depicts channel blocks. The next collection of rows depicts bands and their sub-bands. For example, the band AWS includes sub-bands AWS A1 (CMA); AWS A2 (CMA); AWS B1 (EA); AWS B2 (EA); AWS C (EA); AWS D (REAG); AWS E (REAG); AWS F1 (REAG); and AWS F2 (REAG). Another example is the PCS band, the sub-bands of which include PCS A1 (MTA); PCS A2 (MTA); PCS A3 (MTA); PCS D (BTA); PCS B1 (MTA); PCS B2 (MTA); PCS B3 (MTA); PCS E (BTA); PCS F (BTA); PCS C1 (BTA); PCS C2 (BTA); PCS C3 (BTA); all sub-bands PCS G (National); and off band AWS-2 (Not ADctioned). The next row depicts channel bandwidths in megahertz. The next collection of rows depicts market names, states, and counties, and licensed carriers for those geographic locations.

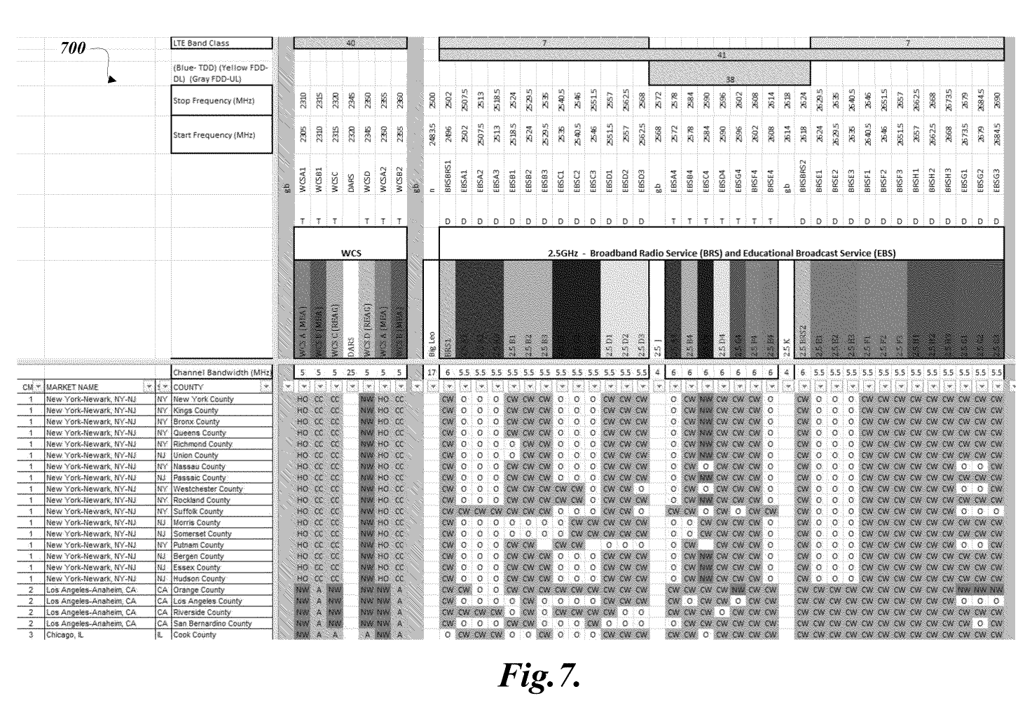

FIG. 7 illustrates user interface in the form of a matrix 700. The matrix includes rows. The first row depicts LTE Band Class for which the class is TDD if it appears in blue, FDD-DL if it appears in yellow, and FDD-UL if it appears in gray. The next row depicts stop frequencies in megahertz. The next row depicts start frequencies in megahertz. The next row depicts spectrum codes. The following row depicts channel blocks. The next collection of rows depicts bands and their channels. For example, the matrix 700 depicts the WCS band with various channels including WCS A (MEA); WCS B (MEA); WCS C (REAG); DARS; WCS D (REAG); WCS A (MEA); and WCS B (MEA). As another example, the matrix 700 depicts the 2.5 GHz band or cases where it is known as Broadband Radio Service (BRS) and Educational Broadcast Service (EBS). Various channels are available under the 2.5 GHz band, including Big Leo; BRS 1; 2.5 A1; 2.5 A2; 2.5 A3; 2.5 B1; 2.5 B2; 2.5 B3; 2.5 C1; 2.5 C2; 2.5 C3; 2.5 D1; 2.5 D2; 2.5 D3; 2.5 J; 2.5 A4; 2.5 B4; 2.5 CA; 2.5 D4; 2.5 G4; 2.5 F4; 2.5 EA; 2.5 K; 2.5 BRS2; 2.5 E1; 2.5 E2; 2.5 E3; 2.5 F1; 2.5 F2; 2.5 F3; 2.5 H1; 2.5 H2; 2.5 H3; 2.5 G1; 2.5 G2; and 2.5 G3. The next row depicts channel bandwidths in megahertz. The next collection of rows depicts market names, states, and counties and various carriers that are licensed in those geographic areas.

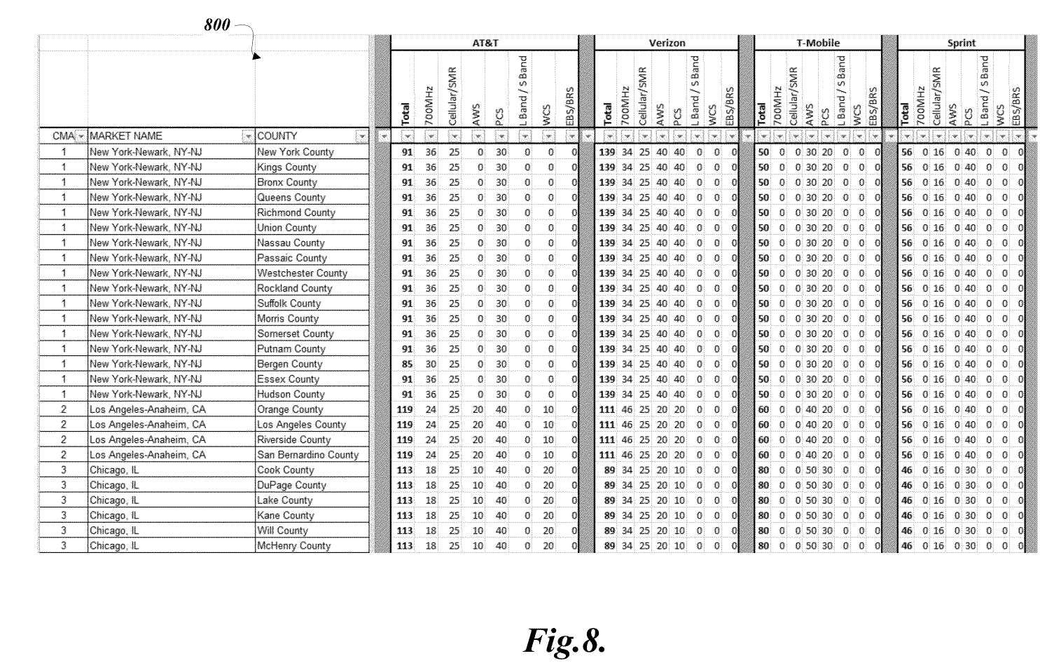

FIG. 8 illustrates a user interface in the form of a matrix 800 showing wireless carriers' licensed data by companies and by band summaries, including Total, 700 megahertz, Cellular/SMR, AWS, PCS, L Band/S Band, WCS, and EBS/BRS. The first row of the matrix 800 depicts different companies, such as AT&T, Verizon, T-Mobile, and Sprint. The next row depicts various bands, including Total, 700 megahertz, Cellular/SMR, AWS, PCS, L Band/S Band, WCS, and EBS/BRS. The next collection of rows depicts CMA, market names, and the counties in which various companies have licenses under the various bands.

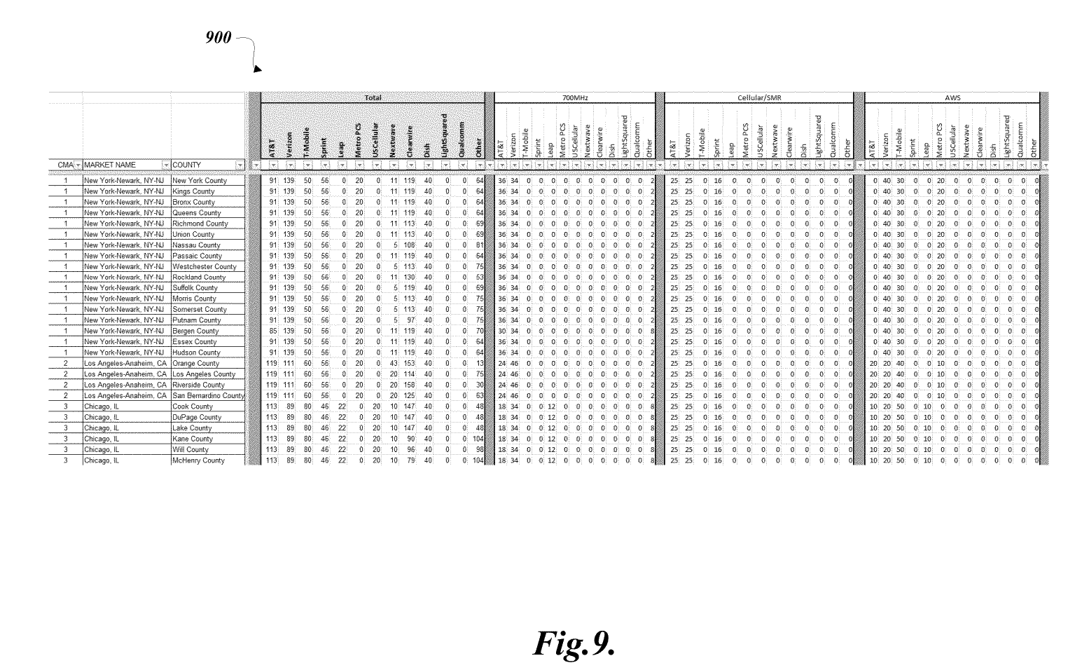

FIG. 9 illustrates a user interface in the form of a matrix 900 showing market by band summaries such as Total, 700 megahertz, Cellular/MMR, and AWS. The first row depicts the various bands, including Total, 700 megahertz, Cellular/MMR, and AWS. The next row depicts various companies owning licenses under the various bands such as AT&T, Verizon, T-Mobile, Sprint, Leap, Metro PCS, USCellular, Nextwave, Clearwire, Dish, LightSquared, Qualcomm, and Other. The next collection of rows depicts CMA, market names, and counties within which licenses are available to various companies.

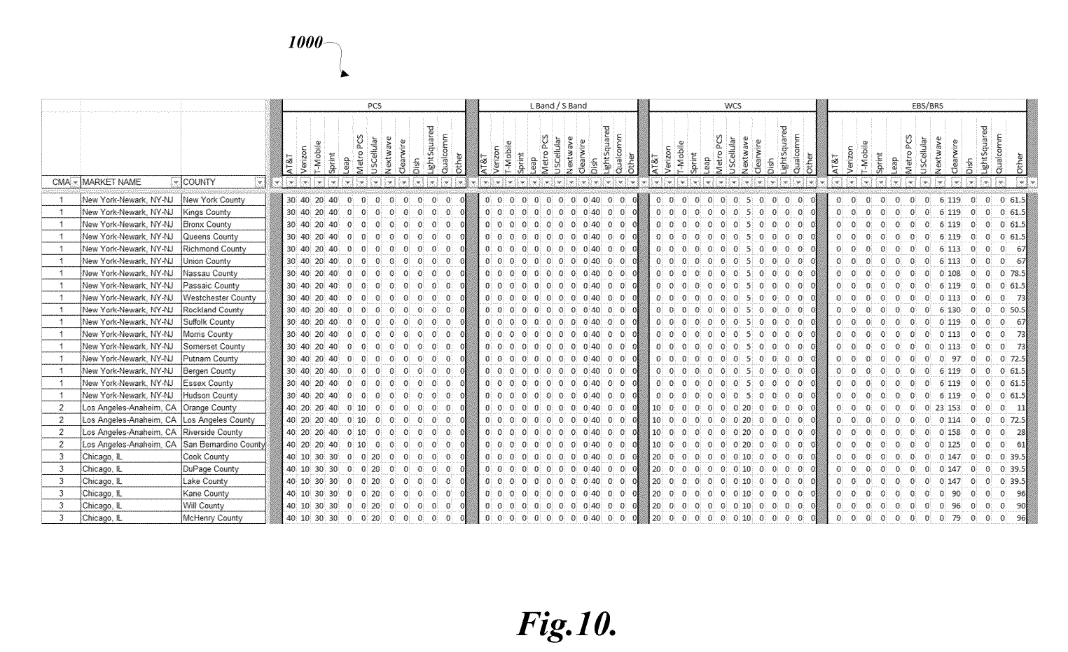

FIG. 10 illustrates a user interface in the form of a matrix 1000 with columns and rows. The first column of the matrix 1000 depicts various bands, including PCS, L Band/S Band, WCS, and EBS/BRS. The next row depicts various companies within a band, including AT&T, Verizon, T-Mobile, Sprint, Leap, Metro PCS, USCellular, Nextwave, Clearwire, Dish, LightSquared, Qualcomm, and Other. The next collection of rows depicts CMA, market names, and counties in which the various companies have licenses.

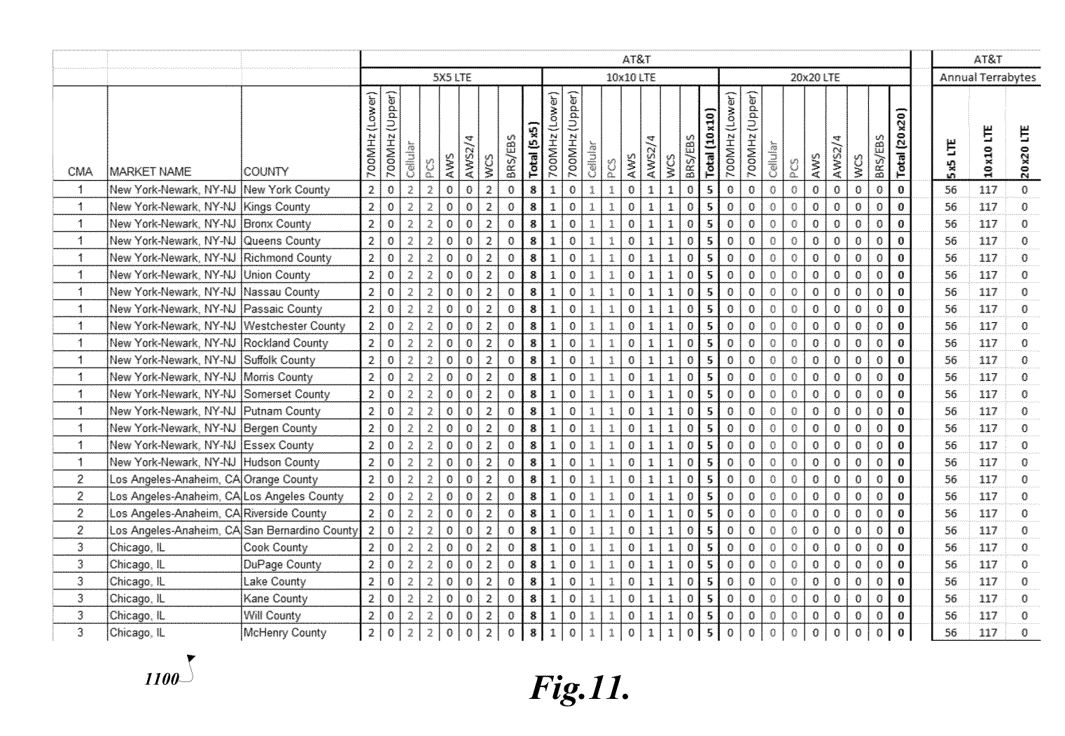

FIG. 11 illustrates a user interface in the form of a matrix 1100 with columns and rows. The first row depicts a particular company or license carrier, which in this case is AT&T. The next row depicts various LTE channel summaries, including 5×5 LTE, 10×10 LTE, 20×20 LTE, and Annual Terabytes. The next row depicts various bands, including 700 megahertz (Lower), 700 megahertz (Upper), Cellular, PCS, AWS, AWS2/4, WCS, BRS/EBS, and Total for that particular LTE channel summary. The matrix 1100 includes a summary for 5/5 LTE, 10×10 LTE, and 20×20 LTE channels. The next collection of rows depicts CMA, market names, and counties in which licenses are available under various bands and under various LTE channel summaries. All of these are summarized for a particular company.

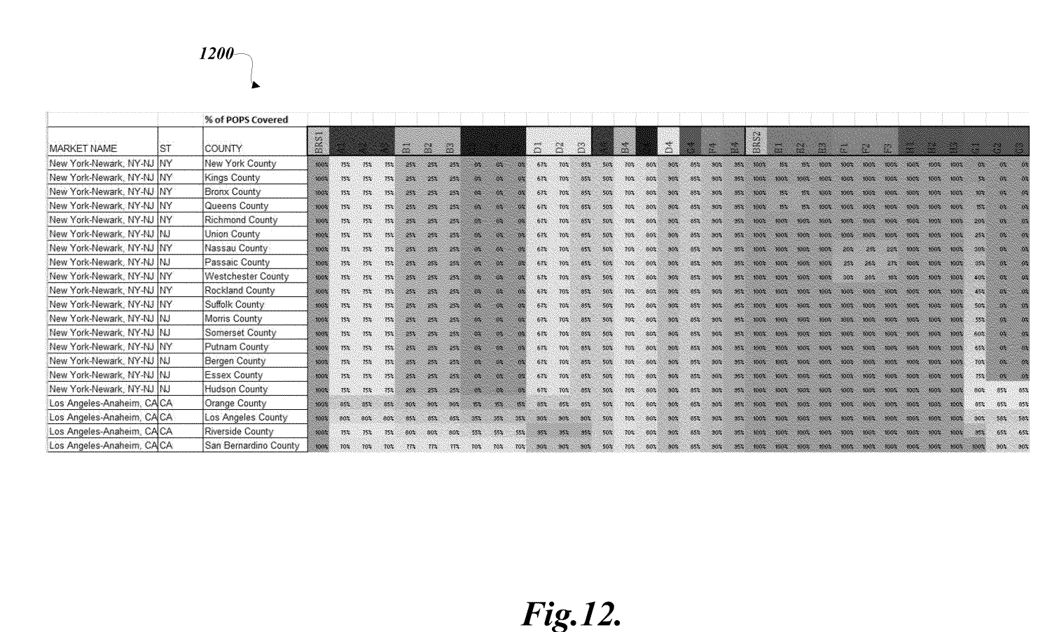

FIG. 12 illustrates a user interface in the form of a matrix 1200 of columns and rows. The matrix 1200 illustrates EBS/BRS percentage of population covered by a carrier's licenses. The first row depicts various EPS/BRS bands including BRS1; A1; A2; A3; B1; B2; B3; C1; C2; C3; D1; D2; D3; A4; B4; C4; D4; G4; F4; E4; BRS2; BRS2 E1; BRS2 E2; BRS2 E3; BRS2 F1; BRS2 F2; BRS2 F3; BRS2 H1; BRS2 H2; BRS2 H3; BRS2 G1; BRS2 G2; and BRS2 G3. The next collection of rows depicts market names, states, and counties in which coverage percentages are illustrated under the various EPS/BRS bands.

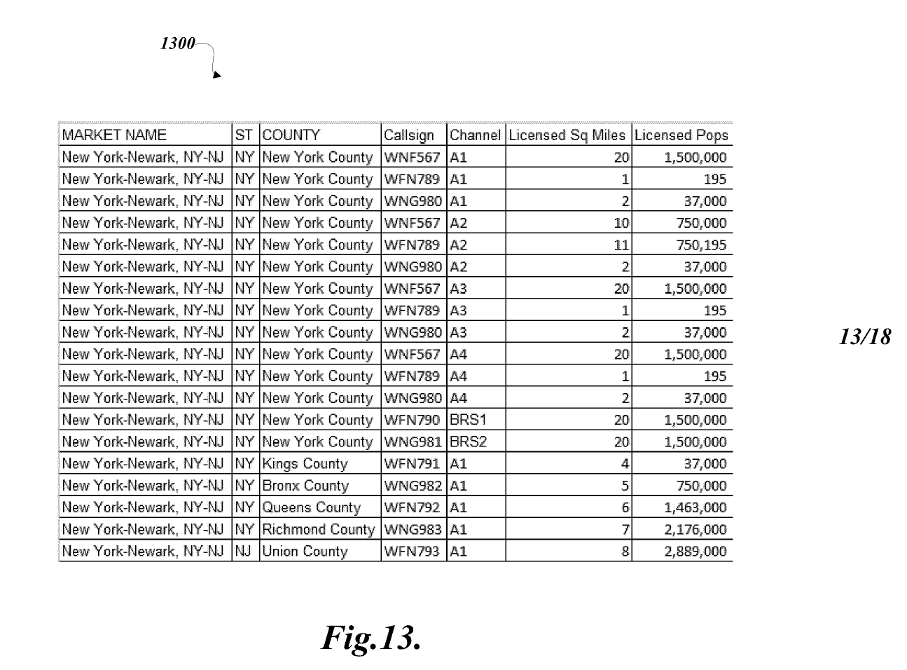

FIG. 13 illustrates a matrix 1300 containing pieces of information in columns and rows to generate the user interface depicted by the matrix 1200. The matrix 1300 contains information compiled to create a total individual carrier covered population (POPS) within a county. The percentage in the user interface 1200 is found by dividing the total carrier covered population. The matrix 1300 includes various columns such as Market Name, State, County, Callsign, Channel, Licensed Square Miles, and Licensed Populations. The rows under the column “Market Name” contain market names of the licensed spectrum. The rows under the column “State” contain states in which licenses are provided. The rows under the column “County” contain counties in which licenses are provided. The rows under the column “Call sign” contain call signs of radio services. The rows under the column “Channel” contain the channels of bands in operation at specified geographic locations. The rows under the column “Licensed Square Miles” contain the square mile scope in which the radio services communicate information. The rows under the column “Licensed Population” contain the population size citizens served by the radio services.

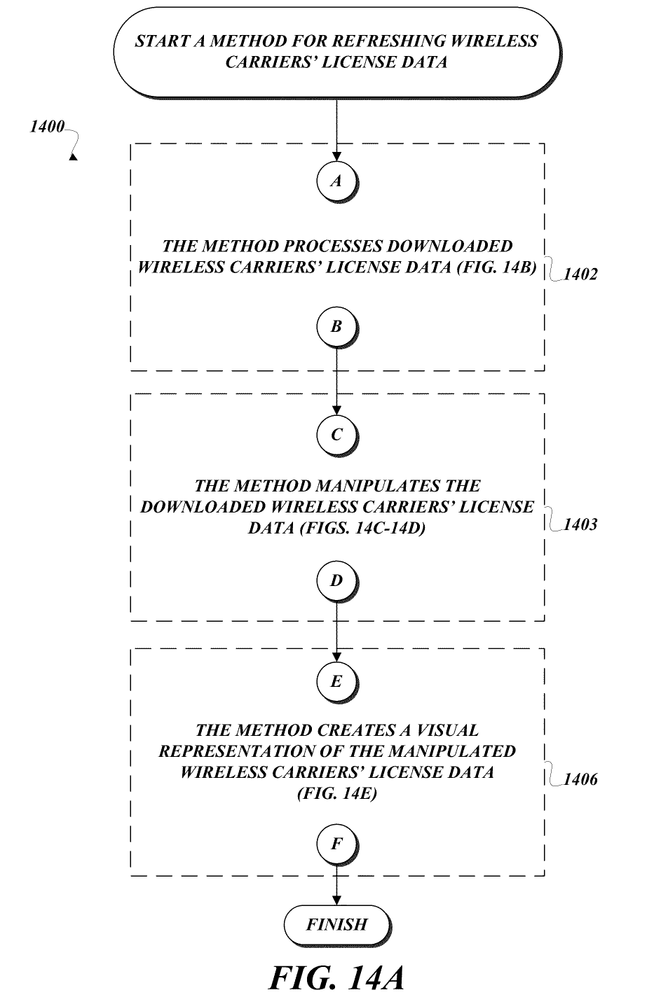

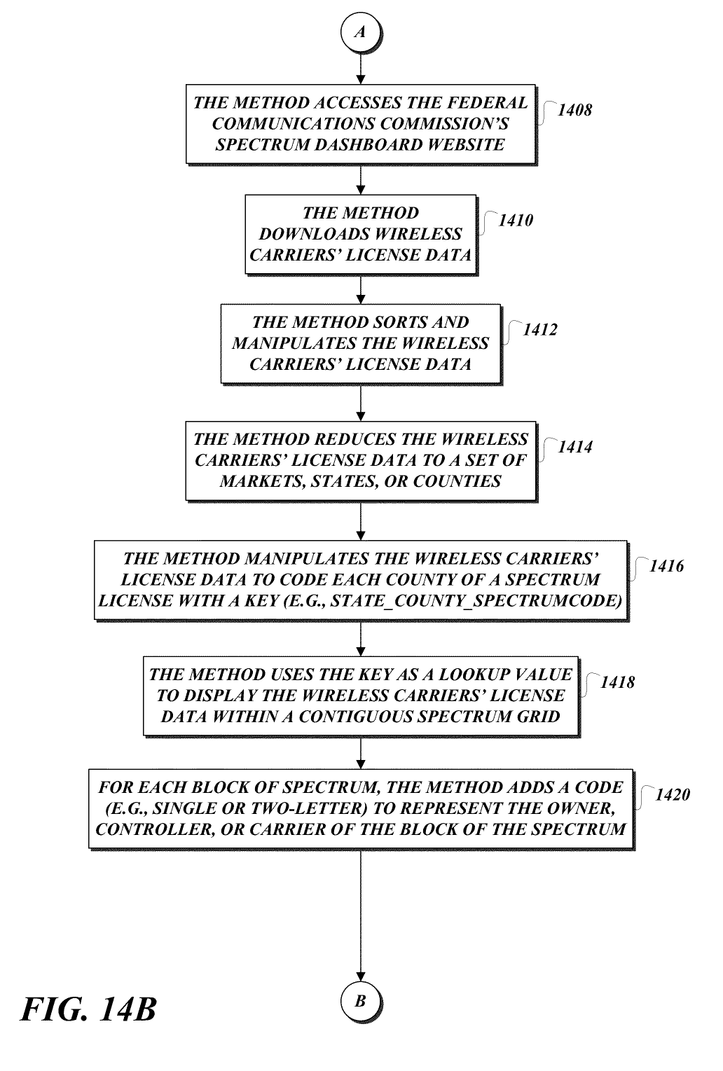

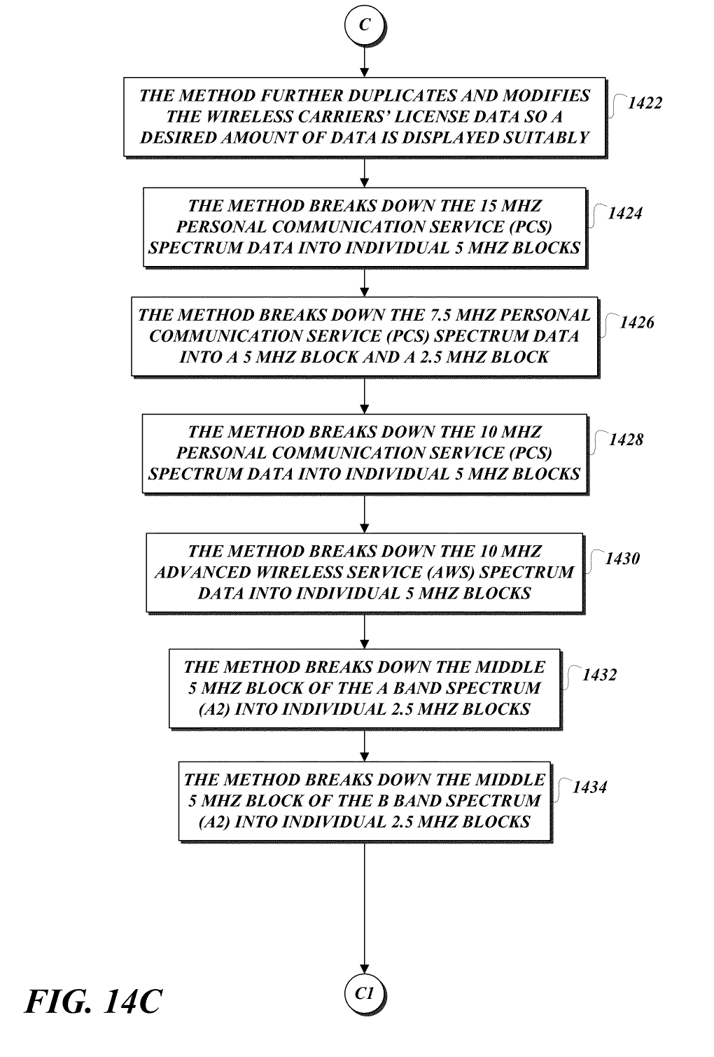

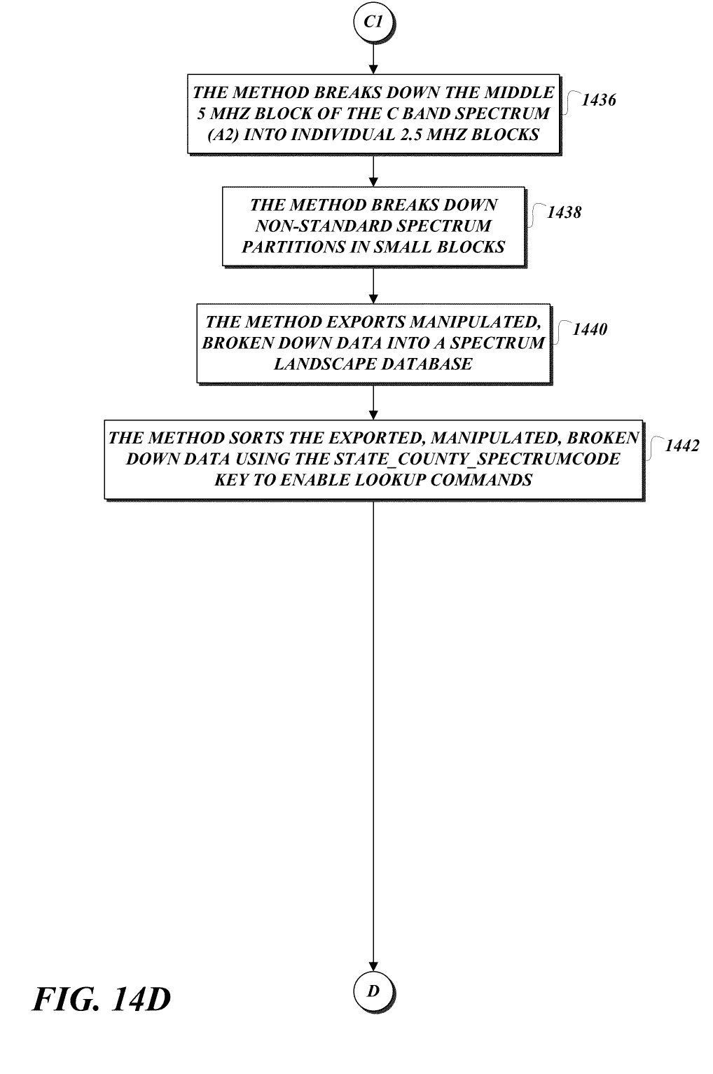

FIGS. 14A-14E are process diagrams implementing a method 1400 for refreshing wireless carriers' license data. From a start block, the method 1400 proceeds to a set of method steps 1402 defined between a continuation terminal (“terminal A”) and another continuation terminal (“terminal B”). The set of method steps 1402 execute steps suitable for downloading wireless carriers' license data. From terminal A (FIG. 14B), the method proceeds to block 1408 where the method accesses the Federal Communication Commission's spectrum dashboard website. At block 1410, the method downloads wireless carriers' license data. At block 1412, the method sorts and manipulates the wireless carriers' license data. At block 1414, the method reduces the wireless carriers' license data to a set of markets, states, or counties. At block 1416, the method manipulates the wireless carriers' license data to code each county of a spectrum license with a key (e.g., State_County_SpecCode). At block 1418, the method uses the key as a lookup value to display the wireless carriers' license data within a contiguous spectrum grid. At block 1420, for each block of spectrum, the method adds a code (e.g., single or two-letter) to represent the owner, controller, or carrier of the block of the spectrum. The method then continues to terminal B.

From terminal B (FIG. 14A), the method proceeds to a set of method steps 1403 defined between a continuation terminal (“terminal C”) and another continuation terminal (“terminal D”). The set of method steps 1403 manipulates the downloaded wireless carriers' license data. From terminal C (FIG. 14C), the method proceeds to block 1422 where the method further duplicates and modifies the wireless carriers' license data so a desired amount of data is displayed suitably. At block 1424, the method breaks down the 15 megahertz personal communication service (PCS) spectrum data into individual 5 megahertz blocks. At block 1426, the method breaks down the 7.5 megahertz personal communication service (PCS) spectrum data into a 5 megahertz block and a 2.5 megahertz block. At block 1428, the method breaks down the 10 megahertz personal communication service (PCS) spectrum data into individual 5 megahertz blocks. At block 1430, the method breaks down the 10 megahertz advanced wireless service (AWS) spectrum data into individual 5 megahertz blocks. At block 1432, the method breaks down the middle 5 megahertz block of the A band spectrum (A2) into individual 2.5 megahertz blocks. At block 1434, the method breaks down the middle 5 megahertz block of the B band spectrum (A2) into individual 2.5 megahertz blocks. The method then continues to another continuation terminal (“terminal C1”).

From terminal C1 (FIG. 14D), the method proceeds to block 1436 where the method breaks down the middle 5 megahertz block of the C band spectrum (A2) into individual 2.5 megahertz blocks. At block 1438, the method breaks down non-standard spectrum partitions in small blocks. At block 1440, the method exports manipulated, broken down data into a spectrum landscaped database. At block 1442, the method sorts the exported, manipulated, and broken down data using the State_County_SpectrumCode key to enable lookup commands. The method then continues to terminal D. From terminal D (FIG. 14A), the method proceeds to a set of method steps 1406 defined between a continuation terminal (“terminal E”) and another continuation terminal (“terminal F”). The set of method steps 1406 creates a visual representation of the user interfaces of the manipulated wireless carriers' license data.

From terminal E (FIG. 14E), the method prepares to create user interfaces to present the data by spectrum ownership of each carrier. See block 1444. At block 1446, the method combines different licenses and licensee names within a market or spectrum band so a carrier's complete spectrum holding within a spectrum band can be determined. At block 1448, the method presents data representing which carriers own the adjacent spectrum. At block 1450, the method determines the largest blocks of spectrum that each carrier could utilize for their 4G network deployment. The method then continues to terminal F and terminates execution.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method comprising:
accessing a data source containing wireless carriers' license data;
downloading the wireless carriers' license data to obtain downloaded data;
sorting the downloaded data to obtain sorted data;
reducing the sorted data to reduced data within a set of markets, states, and counties;
manipulating the reduced data to code each county of a license with a key comprising a state, a county, and a spectrum code, so as to form manipulated data; and
presenting the manipulated data by using the key as a lookup value so as to display the wireless carriers' license data in a spectrum matrix.

2. The method of claim 1, further comprising adding a code representing a carrier in each block of spectrum.

3. The method of claim 1, wherein manipulating includes duplicating and modifying the reduced data so a desired amount of data can be suitably displayed.

4. The method of claim 1, wherein manipulating includes breaking down the 15 megahertz personal communication service (PCS) spectrum data into individual 5 megahertz blocks.

5. The method of claim 1, wherein manipulating includes breaking down the 7.5 megahertz personal communication service (PCS) spectrum data into 5 megahertz blocks and 2.5 megahertz blocks.

6. The method of claim 1, wherein manipulating includes breaking down the 10 megahertz personal communication service (PCS) spectrum data into individual 5 megahertz blocks.

7. The method of claim 1, wherein manipulating includes breaking down the 10 megahertz advanced wireless service (AWS) spectrum data into individual 5 megahertz blocks.

8. The method of claim 1, wherein manipulating includes breaking down the middle 5 megahertz block of the A band spectrum (A2) into individual 2.5 megahertz blocks.

9. The method of claim 1, wherein manipulating includes breaking down the middle 5 megahertz block of the B band spectrum (A2) into individual 2.5 megahertz blocks.

10. The method of claim 1, wherein manipulating includes breaking down the middle 5 megahertz block of the C band spectrum (A2) into individual 2.5. megahertz blocks.

11. The method of claim 1, wherein manipulating includes breaking down non-standard spectrum partitions into small blocks.

12. The method of claim 1, wherein presenting includes creating user interfaces to present the manipulated data by spectrum ownership of each carrier.

13. The method of claim 1, wherein presenting includes combining different licenses and licensee names within a market or spectrum band so a carrier's spectrum holding within a spectrum band can be determined.

14. The method of claim 1, wherein presenting includes presenting manipulated data to illustrate which carriers own an adjacent spectrum.

15. The method of claim 1, further comprising determining the largest blocks of spectrum that each carrier could utilize for their 4G network deployment.

16. A non-transitory computer-readable medium having computer-executable instructions stored there on to implement a method, comprising:
accessing a data source containing wireless carriers' license data;
downloading the wireless carriers' license data to obtain downloaded data;
sorting the downloaded data to obtain sorted data;
reducing the sorted data to reduced data within a set of markets, states, and counties;
manipulating the reduced data to code each county of a license with a key comprising a state, a county, and a spectrum code, so as to form manipulated data; and
presenting the manipulated data by using the key as a lookup value so as to display the wireless carriers' license data in a spectrum matrix.

17. The computer-readable medium of claim 16, wherein presenting includes creating user interfaces to present the manipulated data by spectrum ownership of each carrier.

18. The computer-readable medium of claim 16, wherein presenting includes presenting manipulated data to illustrate which carriers own an adjacent spectrum.

19. The computer-readable medium of claim 16, further comprising determining the largest blocks of spectrum that each carrier could utilize for their 4G network deployment.

20. A system comprising:
a computer, the hardware structures of which are suitable to implement the steps:
accessing a data source containing wireless carriers' license data;
downloading the wireless carriers' license data to obtain downloaded data;
sorting the downloaded data to obtain sorted data;
reducing the sorted data to reduced data within a set of markets, states, and counties;
manipulating the reduced data to code each county of a license with a key comprising a state, a county, and a spectrum code, so as to form manipulated data; and
a display, the hardware structure of which is capable of presenting the manipulated data by using the key as a lookup value so as to display the wireless carriers' license data in a spectrum matrix.
